(19) United States
(12) Patent Application Publication
(10) Pub. No.: US 2021/0140510 A1
(43) Pub. Date: May 13, 2021

(54) ENERGY DAMPING LINEAR ACTUATOR

(71) Applicant: Joyson Safety Systems Acquisition LLC, Auburn Hills, MI (US)

(72) Inventors: Michael Hishon, New Baltimore, MI (US); Steven Richards, Greenwood, MI (US); Rudi Grzic, Sterling Heights, MI (US)

(21) Appl. No.: 17/094,375

(22) Filed: Nov. 10, 2020

Related U.S. Application Data
(60) Provisional application No. 62/934,195, filed on Nov. 12, 2019.

(51) Int. Cl. F16F 15/02; F16K 31/122

(52) U.S. Cl. CPC F16F 15/021; F16K 31/122

(57) ABSTRACT

Various implementations include an actuator. The actuator includes a housing and a piston. The housing has a central axis and an inner surface. The housing defines at least one protrusion that extends radially inwardly from the inner surface of the housing. The piston is slidingly disposed within the housing and engages the inner surface of the housing as the piston travels a stroke length within the housing along the central axis. The piston travels from a proximal end to a distal end of the stroke length upon actuation of the actuator. The protrusion is disposed adjacent a distal end of the stroke length and is deformed in a radially outward direction when the piston engages the protrusion.

### CROSS-REFERENCE TO RELATED APPLICATIONS

This application claims the benefit of U.S. Provisional Patent Application No. 62/934,195, filed Nov. 12, 2019, the contents of which are incorporated herein by reference in their entirety.

### BACKGROUND

Pyro-actuated linear actuators, such as are used for vehicle hood lifters, need to be transported safely before being installed. Current linear actuators require an extra packaging feature to contain the piston in the event of an inadvertent deployment. The extra packaging is designed to absorb a portion of the energy of the piston as the piston reaches the end of the piston's stroke to prevent the piston from separating from the housing. This extra packaging adds to the overall cost of the linear actuator assembly.

Thus, there is a desire for a linear actuator with a built-in feature for preventing a piston from separating from the housing in the event of an inadvertent deployment.

### SUMMARY

Various implementations include an actuator. The actuator includes a housing and a piston. The housing has a central axis and an inner surface. The housing defines at least one protrusion that extends radially inwardly from the inner surface of the housing. The piston is slidingly disposed within the housing and engages the inner surface of the housing as the piston travels a stroke length within the housing along the central axis. The piston travels from a proximal end to a distal end of the stroke length upon actuation of the actuator. The protrusion is disposed adjacent a distal end of the stroke length and is deformed in a radially outward direction when the piston engages the protrusion.

In some implementations, the at least one protrusion is an annular protrusion.

In some implementations, the at least one protrusion has a circumferential length that extends less than 360° around the inner surface of the housing.

In some implementations, the at least one protrusion includes at least two protrusions that are circumferentially spaced apart from each other.

In some implementations, the at least one protrusion extends axially along the inner surface.

In some implementations, the at least one protrusion includes at least two protrusions that are axially spaced apart from each other.

In some implementations, the at least one protrusion is integrally formed with the housing.

In some implementations, the at least one protrusion is a groove defined by an outer surface of the housing.

In some implementations, the at least one protrusion is plastically deformed when the piston engages the at least one protrusion.

In some implementations, a thickness of a wall of the housing along the stroke length is equal to a thickness of a wall of the at least one protrusion.

In some implementations, the at least one protrusion is structured such that the deformation of the at least one protrusion by the piston prevents the piston from separating from the housing.

In some implementations, the actuator further includes a gas generator disposed adjacent the proximal end of the stroke length.

In some implementations, a piston rod is coupled to the piston. In some implementations, the piston rod is integrally formed with the piston.

In some implementations, the at least one protrusion is deformed in an axial direction when the piston engages the at least one protrusion.

Various other implementations include an actuator. The actuator includes a housing and a piston. The housing has a central axis and an inner surface. The housing defines at least one annular protrusion that extends radially inwardly from the inner surface of the housing. The piston is slidingly disposed within the housing and engages the inner surface of the housing as the piston travels a stroke length within the housing along the central axis. The piston travels from a proximal end to a distal end of the stroke length upon actuation of the actuator. The protrusion is disposed adjacent a distal end of the stroke length and is deformed in a radially outward direction when the piston engages the protrusion.

In some implementations, the at least one protrusion is integrally formed with the housing.

In some implementations, the at least one protrusion is a groove defined by an outer surface of the housing.

In some implementations, the at least one protrusion is plastically deformed when the piston engages the at least one protrusion.

In some implementations, a thickness of a wall of the housing along the stroke length is equal to a thickness of a wall of the at least one protrusion.

In some implementations, the at least one protrusion is structured such that the deformation of the at least one protrusion by the piston prevents the piston from separating from the housing.

In some implementations, the actuator further includes a gas generator disposed adjacent the proximal end of the stroke length.

### BRIEF DESCRIPTION OF DRAWINGS

Example features and implementations are disclosed in the accompanying drawings. However, the present disclosure is not limited to the precise arrangements and instrumentalities shown. Similar elements in different implementations are designated using the same reference numerals.

FIG. 1A is a side view of an actuator having an energy damping feature, according to one implementation.

FIG. 1B is a cross-sectional side view of the actuator of FIG. 1A along line A-A.

FIG. 1C is the cross-sectional side view of the actuator of FIG. 1B after activation of the actuator.

FIG. 2 is a cross-sectional side view of an actuator having an energy damping feature, according to another implementation.

FIG. 3 is a cross-sectional side view of an actuator having an energy damping feature, according to another implementation.

FIG. 4 is a cross-sectional side view of an actuator having an energy damping feature, according to another implementation.

FIG. 5 is a cross-sectional side view of an actuator having an energy damping feature, according to another implementation.

FIG. 6 is a cross-sectional side view of an actuator having an energy damping feature, according to another implementation.

### DETAILED DESCRIPTION

The devices, systems, and methods disclosed herein provide for an actuator having an energy damping feature. The actuator can be included in a hood lifting mechanism for lifting the hood of a vehicle, for example. The actuator includes a housing and a piston that is slidingly disposed within the housing, and the housing has at least one protrusion adjacent a distal end of a stroke length of the piston. When the piston engages the protrusion as the piston travels along the stroke length, the piston plastically deforms the protrusion, which absorbs some of the kinetic energy of the traveling piston and prevents the piston from separating from the housing. The energy damping feature is formed into the housing so there are no extra parts and eliminates the need for extra packaging containment for the piston.

The housing has a central axis and an inner surface. The protrusion extends radially inwardly from the inner surface of the housing. The piston engages the inner surface of the housing as the piston travels the stroke length within the housing along the central axis. The piston travels from a proximal end to the distal end of the stroke length upon actuation of the actuator. The protrusion is deformed in a radially outward direction when the piston engages the protrusion. For example, the protrusion may include an annular protrusion, a semi-annular protrusion, a protrusion extending along an axial direction, or two or more protrusions that are spaced apart axially and/or radially from each other.

FIG. 1A shows a hood lifting actuator 100 with an energy damping feature according to one implementation. FIG. 1B shows a cross-sectional view of the actuator 100 of FIG. 1A along line A-A. The actuator 100 includes a housing 110 and a piston 140. The housing 110 has a central axis 112 with a housing wall 114 extending circumferentially around the central axis 112. The housing wall 114 has a first end 116, a second end 118 opposite and spaced axially apart from the first end 116, an outer surface 120, and an inner surface 122 opposite and spaced radially inwardly from the outer surface 120. The inner surface 122 of the housing wall 114 defines a channel 124.

The piston 140 is slidingly disposed within the channel 124 of the housing 110, and the piston is sized to engage the inner surface 122 of the housing wall 114. In some implementations, the piston includes a resilient seal (e.g., a rubber ring) extending around the outer circumferential surface of the piston 140, and the resilient seal is the portion of the piston that directly engages the inner surface 122. A piston rod 142 is coupled to the piston 140. Upon activation of the actuator 100, the piston 140 travels a stroke length 144 within the channel 124 along the central axis 112. The stroke length 144 includes a proximal end 146 proximal to the first end 116 of the housing wall 114 and a distal end 148 distal to the proximal end 146. The piston rod 142 shown in FIGS. 1A and 1B is integrally coupled to the piston 140, but in other implementations, the piston rod is separately formed and coupled to the piston by another suitable coupling mechanism, such as fasteners, threading, or adhesives.

The gas generator 150 is coupled to the first end 116 of the housing 110 to introduce pressurized gas into the channel 124 upon actuation. The pressurized gas introduced by the gas generator 150 applies pressure to the piston 140, causing the piston 140 to travel from the proximal end 146 of the stroke length 144 to the distal end 148 of the stroke length 144, as shown in FIG. 1C. For example, the gas generator 150 may be a micro gas generator (MGG). However, in some implementations, the gas generator is not coupled to the first end of the housing but is adjacent to the proximal end of the stroke length and is in fluid communication with the housing to introduce pressurized gas into the channel upon actuation.

The energy damping feature includes a protrusion 130 defined by the housing wall 114. The protrusion 130 extends radially inwardly from the inner surface 122 of the housing wall 114 and into the channel 124. The protrusion 130 is formed integrally with the housing wall 114 along the stroke length 144 and adjacent the distal end 148 of the stroke length 144. A groove 132 is defined in the outer surface 120 of the housing wall 114 such that the inner surface 122 of the housing wall 114 axially adjacent the groove 132 forms the protrusion 130. The protrusion 130 is an annular protrusion 130 extending circumferentially around the central axis 112. As seen in FIGS. 1A and 1B, the protrusion 130 has a protrusion wall thickness 134 that is equal to the thickness 126 of the remainder of the housing wall 114 along the stroke length 144 of the piston 140.

When the piston 140 travels toward the distal end 148 of the stroke length 144, the piston 140 engages the protrusion 130, causing the protrusion 130 to plastically deform. Although the protrusion 130 shown in FIGS. 1A and 1B is formed integrally with the housing wall 114, in other implementations, the protrusion is formed separately from the housing wall and is coupled to the housing wall. Although the protrusion 130 shown in FIGS. 1A and 1B has a protrusion wall thickness 134 equal to the thickness 126 of the housing wall 114, in other implementations, the protrusion wall has a protrusion wall thickness greater or less than the thickness of the housing wall. Although the protrusion 130 shown in FIGS. 1A and 1B is located adjacent the distal end 148 of the stroke length 144, in other implementations, the protrusion is located anywhere along the stroke length 144.

The plastic deformation of the protrusion 130 absorbs at least a portion of the kinetic energy of the piston 140 at the distal end 148 of the stroke length 144 during a dry fire test and causes the piston 140 to remain in the housing 110. A dry fire test includes deploying the actuator 100 without a load on the piston 140 and is performed to simulate an accidental ignition during transport of a hood lifting mechanism that includes actuator 100. In particular, when the piston 140 engages the protrusion 130 at the distal end 148 of the stroke length 144, the piston 140 deforms the protrusion 130 in at least a radially outward direction, which absorbs at least a portion of the energy released in the dry fire test. Thus, the protrusion 130 is structured such that the deformation of the protrusion 130 by the piston 140 absorbs at least a portion of the energy of the piston 140 and prevents the piston 140 from separating from the housing 110. Although the piston 140 deforms the protrusion 130 in at least a radially outward direction, in some implementations, the piston also, or alternatively, deforms the protrusion in an axial direction when the piston engages the protrusion.

The protrusion 130 shown in FIGS. 1A and 1B is an annular protrusion 130, but in other implementations, the protrusion may have another suitable shape and/or may comprise two or more spaced apart protrusions. In some implementations, the actuator has two or more protrusions that are spaced apart axially and/or circumferentially. For example, FIG. 2 shows an actuator 200 having a semi-annular protrusion 230 that circumferentially extends only partially around the inner surface 222 of the housing wall 214. Thus, the circumferential length of the protrusion 230 extends less than 360° around the inner surface 222 of the housing wall 214.

FIG. 3 shows another implementation of an actuator 300 having a first protrusion 330a and a second protrusion 330b. The first protrusion 330a and the second protrusion 330b are spaced apart from each other circumferentially around the inner surface 322 of the housing wall 314.

FIG. 4 shows another implementation of an actuator 400 having a first protrusion 430a, a second protrusion 430b, and a third protrusion 430c. The first protrusion 430a, the second protrusion 430b, and the third protrusion 430c are spaced apart from each other circumferentially around the inner surface 422 of the housing wall 414.

FIG. 5 shows another implementation of an actuator 500 having a protrusion 530 that extends axially along the inner surface 522 of the housing wall 514.

FIG. 6 shows yet another implementation of an actuator 600 having a first protrusion 630a and a second protrusion 630b. The first protrusion 630a and the second protrusion 630b are spaced apart from each other axially along the inner surface 622 of the housing wall 614.

A number of implementations have been described. Nevertheless, it will be understood that various modifications may be made without departing from the spirit and scope of the claims. Accordingly, other implementations are within the scope of the following claims.

Certain terminology is used herein for convenience only and is not to be taken as a limitation on the present claims. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

1. An actuator comprising:
a housing having a central axis and an inner surface, the housing defining at least one protrusion that extends radially inwardly from the inner surface of the housing; and
a piston slidingly disposed within the housing and engaging the inner surface of the housing as the piston travels a stroke length within the housing along the central axis, the piston traveling from a proximal end to a distal end of the stroke length upon actuation of the actuator,
wherein the protrusion is disposed adjacent a distal end of the stroke length and is deformed in a radially outward direction when the piston engages the protrusion.

2. The actuator of claim 1, wherein the at least one protrusion is an annular protrusion.

3. The actuator of claim 1, wherein the at least one protrusion has a circumferential length that extends less than 360° around the inner surface of the housing.

4. The actuator of claim 1, wherein the at least one protrusion comprises at least two protrusions that are circumferentially spaced apart from each other.

5. The actuator of claim 1, wherein the at least one protrusion extends axially along the inner surface.

6. The actuator of claim 1, wherein the at least one protrusion comprises at least two protrusions that are axially spaced apart from each other.

7. The actuator of claim 1, wherein the at least one protrusion is integrally formed with the housing.

8. The actuator of claim 1, wherein the at least one protrusion is a groove defined by an outer surface of the housing.

9. The actuator of claim 1, wherein the at least one protrusion is plastically deformed when the piston engages the at least one protrusion.

10. The actuator of claim 1, wherein a thickness of a wall of the housing along the stroke length is equal to a thickness of a wall of the at least one protrusion.

11. The actuator of claim 1, wherein the at least one protrusion is structured such that the deformation of the at least one protrusion by the piston prevents the piston from separating from the housing.

12. (canceled)

13. The actuator of claim 1, wherein a piston rod is coupled to the piston.

14. The actuator of claim 13, wherein the piston rod is integrally formed with the piston.

15. The actuator of claim 1, wherein the at least one protrusion is deformed in an axial direction when the piston engages the at least one protrusion.

16. An actuator comprising:
a housing having a central axis and an inner surface, the housing defining at least one annular protrusion that extends radially inwardly from the inner surface of the housing; and
a piston slidingly disposed within the housing and engaging the inner surface of the housing as the piston travels a stroke length within the housing along the central axis, the piston traveling from a proximal end to a distal end of the stroke length upon actuation of the actuator, wherein the protrusion is disposed adjacent a distal end of the stroke length and is deformed in a radially outward direction when the piston engages the protrusion.

17. The actuator of claim 16, wherein the at least one protrusion is integrally formed with the housing.

18. The actuator of claim 16, wherein the at least one protrusion is a groove defined by an outer surface of the housing.

19. The actuator of claim 16, wherein the at least one protrusion is plastically deformed when the piston engages the at least one protrusion.

20. The actuator of claim 16, wherein a thickness of a wall of the housing along the stroke length is equal to a thickness of a wall of the at least one protrusion.

21. The actuator of claim 16, wherein the at least one protrusion is structured such that the deformation of the at least one protrusion by the piston prevents the piston from separating from the housing.

22. (canceled)
